(19) United States
(12) Patent Application Publication
(10) Pub. No.: US 2008/0219577 A1
(43) Pub. Date: Sep. 11, 2008

(54) Encoding device and image recording device

(75) Inventor: Norihisa Hagiwara, Hachioji (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/074,465

(22) Filed: Mar. 3, 2008

(30) Foreign Application Priority Data
Mar. 9, 2007 (JP) 2007-59901

(51) Int. Cl. G06K 9/36

(52) U.S. Cl. 382/246

(57) ABSTRACT

An encoding device including: a variable-length code table generation section generating a variable-length code table based on first image data acquired by a first imaging section; and an encoded information generation section generating encoded information by encoding second image data acquired by a second imaging section based on the variable-length code table generated by the variable-length code table generation section.

Japanese Patent Application No. 2007-59901, filed on Mar. 9, 2007, is hereby incorporated by reference in its entirety.

### BACKGROUND OF THE INVENTION

The present invention relates to an encoding device and an image recording device.

Technology is known which reduces the amount of information by compressing data in order to efficiently process data with a large amount of information such as an image and sound. As the data compression technology, encoding technology utilizing a variable-length code table is known.

According to the variable-length encoding technology, the amount of information after encoding may differ depending on the applied code table. The amount of information after encoding can be minimized by applying a code table optimum for the encoding target data (e.g., image data of one frame). Various methods such as a Huffman code method and an arithmetic code method have been proposed as encoding technology which creates a code table optimum for the encoding target data.

A code table optimum for the encoding target data generally differs depending on the encoding target data. Therefore, the amount of information after encoding can be reduced by creating a code table for each piece of the encoding target data. However, the processing load increases when creating a code table for all pieces of the encoding target data, thereby making it difficult to process the data in real time.

A de-facto variable-length code table may be defined depending on the encoding technology. Data can be encoded utilizing such a de-facto variable-length code table without creating a variable-length code table. For example, JPEG data may be encoded utilizing a typical variable-length code table described in ISO/IEC 10918-1 Annex K.

However, a code table defined in advance is rarely optimum for all pieces of the encoding target data. It may be difficult to encode data at a high compression rate when utilizing a code table defined in advance.

### SUMMARY

According to a first aspect of the invention, there is provided an encoding device comprising:

a variable-length code table generation section generating a variable-length code table based on first image data acquired by a first imaging section; and

an encoded information generation section generating encoded information by encoding second image data acquired by a second imaging section based on the variable-length code table generated by the variable-length code table generation section.

According to a second aspect of the invention, there is provided an image recording device comprising:

the above-described encoding device;

the first imaging section;

the second imaging section; and

a storage section storing the encoded information.

### BRIEF DESCRIPTION OF THE SEVERAL VIEWS OF THE DRAWING

FIG. 1 is a diagram illustrative of the configuration of an encoding device.

FIG. 2 is a diagram illustrative of the configuration of an encoding device.

FIG. 3 is a diagram illustrative of the configuration of an image recording device.

FIGS. 4A and 4B are diagrams showing an example of data processed by an encoding device.

FIG. 5 is a diagram showing an example of data processed by an encoding device.

FIG. 6 is a diagram showing an example of data processed by an encoding device.

FIG. 7 is a diagram showing an example of data processed by an encoding device.

FIG. 8 is a table showing an example of data processed by an encoding device.

FIG. 9 is a flowchart illustrative of an operation of an encoding device.

FIG. 10 is a flowchart illustrative of an operation of an encoding device.

FIG. 11 is a diagram illustrative of an operation of an encoding device.

FIG. 12 is a diagram illustrative of an operation of an encoding device.

FIG. 13 is a diagram illustrative of an operation of an encoding device.

FIG. 14 is a diagram illustrative of an operation of an encoding device.

### DETAILED DESCRIPTION OF THE EMBODIMENT

The invention may provide an encoding device and an image recording device, both of which can efficiently generate encoded data at a high compression rate.

(1) According to one embodiment of the invention, there is provided an encoding device comprising:

a variable-length code table generation section generating a variable-length code table based on first image data acquired by a first imaging section; and

an encoded information generation section generating encoded information by encoding second image data acquired by a second imaging section based on the variable-length code table generated by the variable-length code table generation section.

According to this embodiment, the second image data can be encoded without generating a variable-length code table based on the second image data. Therefore, the second image data can be efficiently encoded. According to this embodiment, the second image data is encoded utilizing the variable-length code table generated based on the first image data (i.e., variable-length code table optimum for the first image data) instead of a de-facto code table. Therefore, the second image data can be encoded at a high compression rate as compared with the case of utilizing a de-facto code table.

According to this embodiment, an encoding device can be provided which can efficiently encode the second image data at a high compression rate.

(2) In this encoding device,

the first imaging section may acquire a plurality of pieces of the first image data in time series; and

the variable-length code table generation section may generate a plurality of the variable-length code tables, each of the variable-length code tables being generated based on one of the pieces of the first image data.

(3) In this encoding device,

the encoded information generation section may encode the second image data based on one of the variable-length code tables generated based on one of the pieces of

the first image data having an acquisition time closest to an acquisition time of the second image data.

This enables the second image data to be encoded based on the variable-length code table generated based on the first image data which has a feature similar to that of the second image data. Therefore, the second image data can be encoded at a high compression rate.

(4) In this encoding device,

the encoded information generation section may encode the second image data based on one of the variable-length code tables generated based on one of the pieces of the first image data having an acquisition time immediately before an acquisition time of the second image data.

This enables the second image data to be encoded based on the variable-length code table generated based on the first image data which has a feature similar to that of the second image data. Therefore, the second image data can be encoded at a high compression rate.

(5) The encoding device may further comprise:

a holding section holding the variable-length code table,

wherein the encoded information generation section may encode at least two pieces of the second image data based on the variable-length code table held in the holding section.

(6) The encoding device may further comprise:

an update event detection section detecting occurrence of a predetermined variable-length code table update event; and

an updating section updating the variable-length code table held in the holding section when the update event detection section has detected the occurrence of the predetermined variable-length code table update event.

This enables the second image data to be encoded based on the variable-length code table optimum for encoding the second image data, whereby the second image data can be encoded at a high compression rate.

(7) In this encoding device,

the update event detection section may detect the occurrence of the predetermined variable-length code table update event when the amount of the encoded information has exceeded a predetermined value.

According to this embodiment, whether or not the variable-length code table is data optimum for encoding the second image data is determined based on the amount of encoded information.

This enables the second image data to be encoded based on the variable-length code table optimum for encoding the second image data, whereby the second image data can be encoded at a high compression rate.

(8) In this encoding device,

the update event detection section may detect the occurrence of the predetermined variable-length code table update event when a predetermined period of time has expired after the acquisition of the first image data.

According to this embodiment, whether or not the variable-length code table is data optimum for encoding the second image data is determined based on the elapsed time from the acquisition time of the first image data. Specifically, the variable-length code table used to encode the second image data is updated corresponding to a change in environment with the passage of time.

This enables the second image data to be encoded based on the variable-length code table optimum for encoding the second image data, whereby the second image data can be encoded at a high compression rate.

(9) In this encoding device,

the update event detection section may detect the occurrence of the predetermined variable-length code table update event when a predetermined period of time has expired after the variable-length code table has been held in the holding section.

According to this embodiment, whether or not the variable-length code table is data optimum for encoding the second image data is determined based on the elapsed time from the generation time of the variable-length code table. Specifically, the variable-length code table used to encode the second image data is updated corresponding to a change in environment with the passage of time.

This enables the second image data to be encoded based on the variable-length code table optimum for encoding the second image data, whereby the second image data can be encoded at a high compression rate.

(10) In this encoding device,

the update event detection section may detect the occurrence of the predetermined variable-length code table update event when a predetermined update time is reached.

According to this embodiment, whether or not the variable-length code table is data optimum for encoding the second image data is determined based on the present time. Specifically, the variable-length code table used to encode the second image data is updated corresponding to a change in environment (e.g., morning, daytime, and night) depending on the time.

This enables the second image data to be encoded based on the variable-length code table optimum for encoding the second image data, whereby the second image data can be encoded at a high compression rate.

(11) In this encoding device,

the update event detection section may detect the occurrence of the predetermined variable-length code table update event when the first image data or the second image data satisfies a predetermined condition.

According to this embodiment, whether or not the variable-length code table is data optimum for encoding the second image data is determined based on the image data before being processed. For example, whether or not the variable-length code table is data optimum for encoding the second image data may be determined based on the total luminance of the first image data and the second image data.

This enables the second image data to be encoded based on the variable-length code table optimum for encoding the second image data, whereby the second image data can be encoded at a high compression rate.

(12) In this encoding device,

the updating section may cause the first imaging section to newly acquire the first image data when the update event detection section has detected the occurrence of the predetermined variable-length code table update event.

Specifically, the encoding device according to this embodiment may be configured to acquire the first image data only when the variable-length code table held in the holding section is updated.

(13) In this encoding device, a resolution of the first image data may be lower than a resolution of the second image data.

Even if the first image data has a resolution lower than that of the second image data, the second image data can be encoded based on the variable-length code table generated based on the first image data.

Moreover, the variable-length code table can be efficiently generated by utilizing image data with a low resolution as the first image data.

(14) The encoding device may further comprise a first image data encoding section encoding the first image data to generate encoded information.

(15) In this encoding device, the first image data encoding section may encode the first image data based on the variable-length code table.

(16) In this encoding device,

the variable-length code table generation section may generate the variable-length code table so that the amount of information of the first image data is equal to or less than a predetermined value after encoding the first image data based on the variable-length code table.

This enables the second image data to be encoded at a high compression rate.

(17) According to one embodiment of the invention, there is provided an image recording device comprising:

the above-described encoding device;

the first imaging section;

the second imaging section; and

a storage section storing the encoded information.

According to this embodiment, the second image data can be encoded without generating a variable-length code table based on the second image data. Therefore, the second image data can be efficiently encoded. According to this embodiment, the second image data is encoded utilizing the variable-length code table generated based on the first image data (i.e., variable-length code table optimum for the first image data) instead of a de-facto code table. Therefore, the second image data can be encoded at a high compression rate as compared with the case of utilizing a de-facto code table.

According to this embodiment, an image recording device can be provided which can efficiently encode the second image data at a high compression rate.

(18) In this image recording device,

the first imaging section and the second imaging section may be disposed adjacently and face in an identical direction.

According to this configuration, the first image data and the second image data are similar types of data. Therefore, the second image data can be encoded at a high compression rate based on the variable-length code table generated based on the first image data.

(19) In this image recording device,

the first image data and the second image data may be acquired by performing an identical process on light incident on the first imaging section and the second imaging section.

Specifically, the first and second imaging sections may have an identical setting relating to a sharpening function, a smoothing feature, or a color filter. The first and second imaging sections may have an identical setting relating to a focal length.

According to this configuration, the degree of similarity of the first image data and the second image data can be increased. This enables the second image data to be encoded at a higher compression rate.

The first and second imaging sections may include a light-receiving element which photoelectrically converts incident light, an optical element (optical system) which causes light to be incident on the light-receiving element, and a processing section which performs a predetermined process on an electrical signal obtained by the light-receiving element. The first and second imaging sections may include identical optical elements (e.g., lenses). The first and second imaging sections may have an identical setting relating to the processing section (e.g., filter).

(20) In this image recording device, the first imaging section and the second imaging section may be provided in one vehicle.

Specifically, the image recording device may be configured as a drive recorder.

Embodiments of the invention will be described below with reference to the drawings. Note that the invention is not limited to the following embodiments. The invention includes configuration in which the elements in the following embodiments and modifications are arbitrarily combined.

1. Configuration of Encoding Device 1

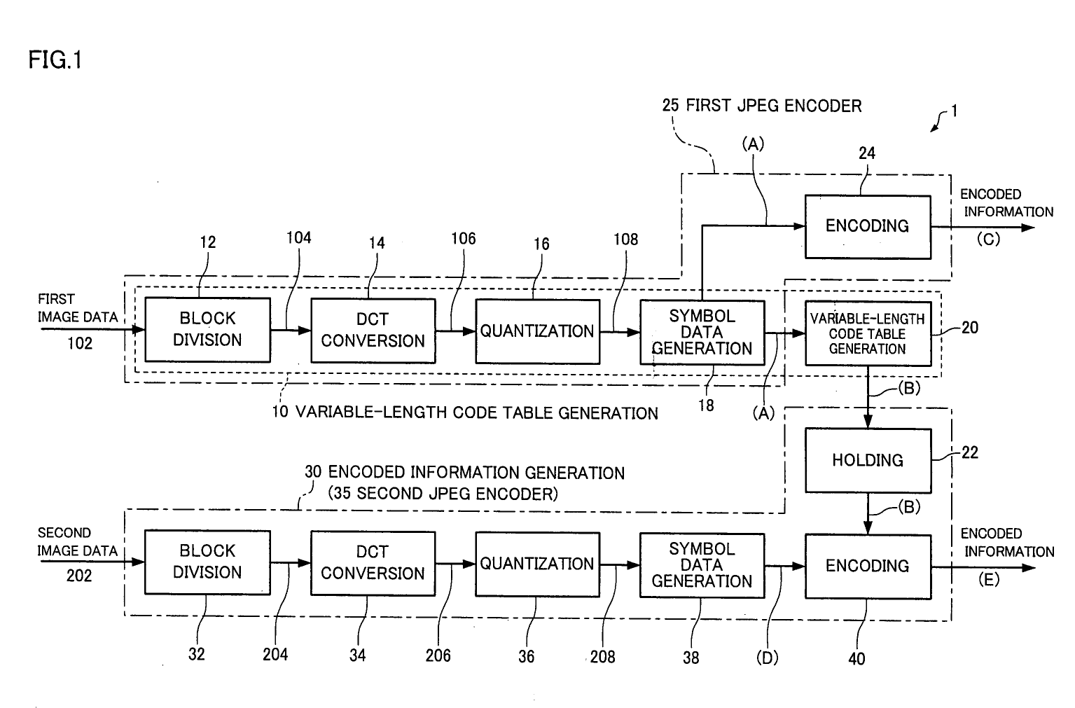

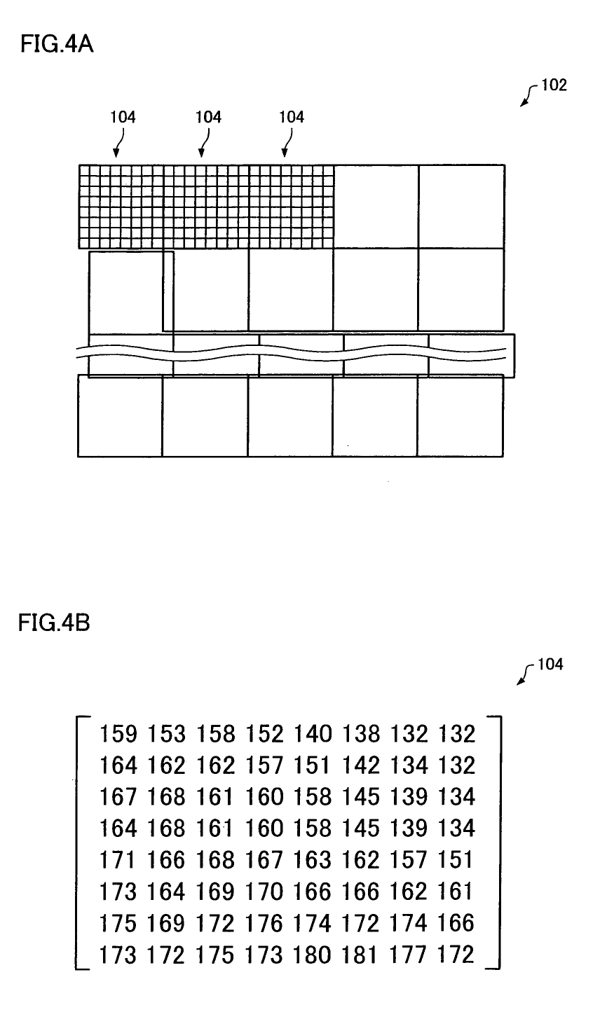

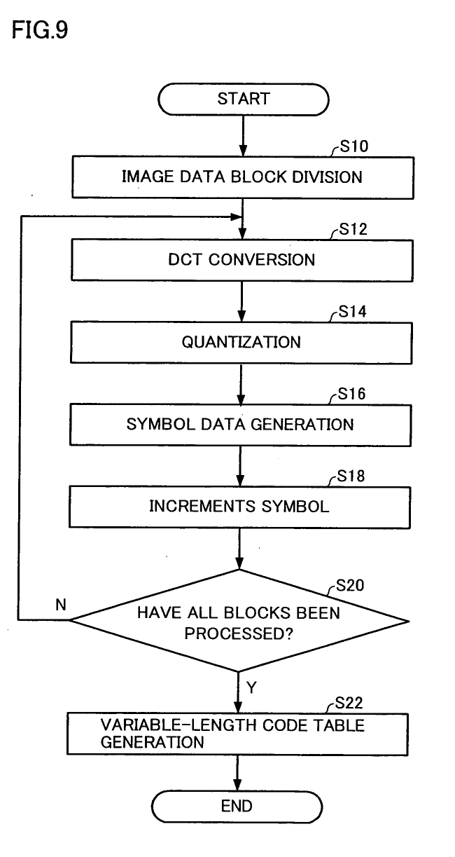

The configuration of an encoding device I according to an embodiment to which the invention is applied is described below. FIGS. 1 to 14 are views illustrative of the encoding device 1. FIGS. 1 to 3 are views illustrative of the configuration of the encoding device 1 (image recording device 2). FIGS. 4A to 8 show examples of data generated in each stage of the encoding device 1. FIGS. 9 to 14 are views illustrative of the operation of the encoding device 1 (image recording device 2). The encoding device 1 according to this embodiment employs a JPEG encoding method. Specifically, the encoding device 1 according to this embodiment may be considered to be a JPEG encoder. Note that the encoding method which may be applied to the encoding device 1 is not limited to the JPEG method. The encoding device 1 may be applied to other types of still picture compression and motion picture compression.

As shown in FIG. 1, the encoding device 1 according to this embodiment includes a variable-length code table generation section 10. The variable-length code table generation section 10 generates a variable-length code table (B) based on first image data 102. The variable-length code table generation section 10 generates the variable-length code table (B) so that the amount of information after encoding is equal to or less than a predetermined value when encoding the first image data 102 based on the generated variable-length code table (B). Specifically, the variable-length code table generation section 10 may generate a code table (variable-length code table) optimum for encoding the first image data 102.

The first image data 102 may be information expressed by a set of pixel values of each pixel (matrix having pixel values as components). The term “pixel value” refers to a value which indicates the intensity of each component of image data. For example, when image data is decomposed into Y/Cr/Cb components, the pixel value indicates the intensities of the Y component, the Cr component, and the Cb component of each pixel. Or, when image data is decomposed into RGB components, the pixel value indicates the intensities of the R component, the G component, and the B component of each pixel. Each process given below may be performed on only one component of image data, or may be performed on a plurality of components of image data.

The variable-length code table generation section 10 is described in detail below.

As shown in FIG. 1, the variable-length code table generation section 10 may include a block division section 12. As shown in FIGS. 4A and 4B, the block division section 12 divides the first image data 102 acquired using a first imaging section into blocks. As shown in FIG. 4A, the block division section 12 divides the first image data 102 into N (N is an integer equal to or greater than two) pieces of block data 104, each pieces of block data 104 containing 8×8 pixels, for example. A DCT conversion section 14 and a quantization section 16 disposed downstream of the block division section 12 in a data flow process all pieces of the block data 104 in units of pieces of the block data 104. FIG. 4B shows an example of the pixel values of the block data 104.

The block division process may be considered to be a preprocess of a DCT conversion process described later. In general, the number of calculations of the DCT conversion process increases along with an increase in the number of pixels contained in the processing target image data by about the second power of the increase in the number of pixels. Therefore, when performing the DCT conversion process on image data containing a large number of pixels, the number of calculations can be reduced by dividing the image data into a plurality of pieces of block data and performing the DCT conversion process in units of pieces of block data. Note that the encoding device 1 may not include the block division section 12.

As shown in FIG. 1, the variable-length code table generation section 10 may include the DCT conversion section 14. The DCT conversion section 14 subjects the block data 104 (pixel values shown in FIG. 4B) to DCT conversion (discrete cosine transform) to calculate DCT coefficients 106 shown in FIG. 5. Various methods such as the type-II DCT have been proposed as the DCT conversion process. Any of these methods may be applied to the invention.

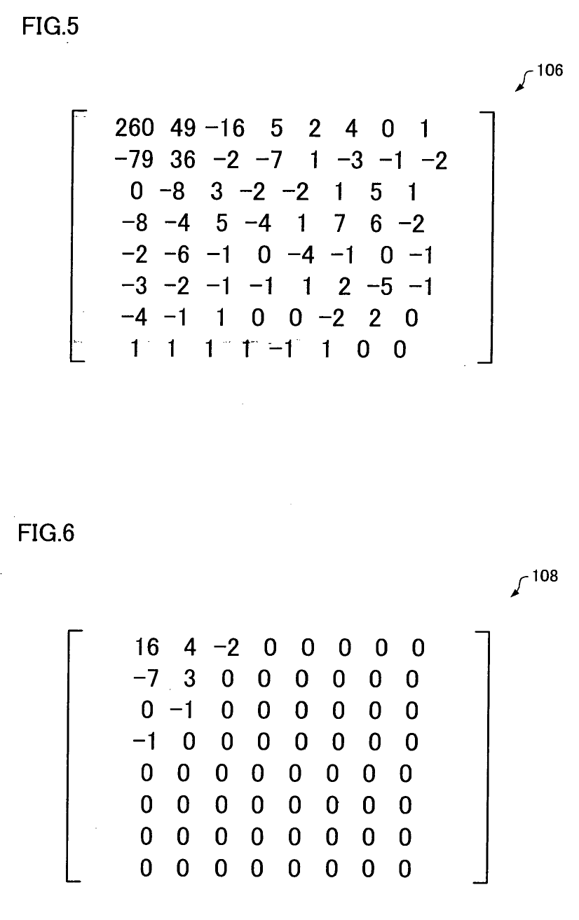

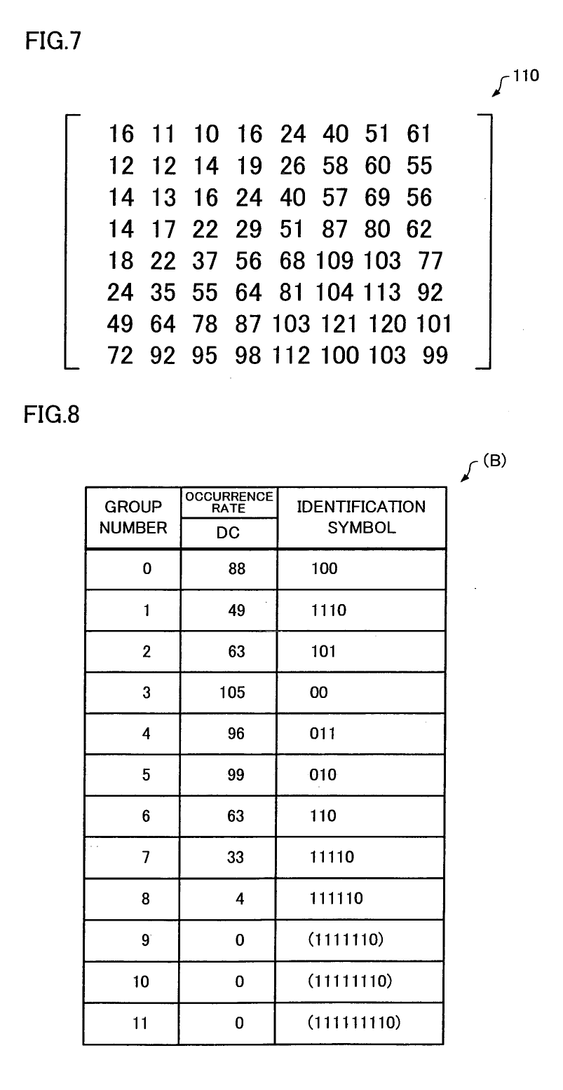

As shown in FIG. 1, the variable-length code table generation section 10 may include the quantization section 16. The quantization section 16 performs a quantization process which quantizes the DCT coefficients 106 using a quantization table to generate quantized DCT coefficients 108 shown in FIG. 6. The quantized DCT coefficients 108 may be simply referred to as DCT coefficients. The quantized DCT coefficients 108 may be generated by dividing each DCT coefficient 106 by a corresponding value in a quantization table 110 shown in FIG. 7 and rounding off to the nearest whole number. In this embodiment, the variable-length code table generation process is performed based on the quantized DCT coefficients 108 generated by the quantization section 16. Note that the variable-length code table generation section 10 according to the invention may not include the quantization section 16. In this case, the following process may be performed based on the DCT coefficients 106 which are not quantized.

As shown in FIG. 1, the variable-length code table generation section 10 may include a symbol data generation section 18. The symbol data generation section 18 converts the quantized DCT coefficients 108 (or DCT coefficients 106) to generate symbol data (A). The symbol data (A) is data obtained by converting the quantized DCT coefficients 108 into a character string (symbol) to which a code word is assigned by an encoding process described later. Specifically, an encoded information generation section described later generates encoded information (compressed data) by assigning a code word to the symbol data (A) (each symbol of the symbol data (A)).

The symbol data generation section 18 converts the quantized DCT coefficients 108 so that the statistical bias of the symbols increases. A specific process of the symbol data generation section 18 is not particularly limited. A process applied to a known method such as differential encoding or predictive encoding may be applied.

The symbol data generation section 18 may generate the symbol data (A) by calculating the difference in DC component between the quantized DCT coefficients 108 obtained from the adjacent pieces of the block data 104, for example. The symbol data generation section 18 may generate the symbol data (A) by scanning AC components of the quantized DCT coefficients 108 contained in the single block data 104 and combining the run length of an invalid coefficient with the value of the subsequent valid coefficient.

As shown in FIG. 1, the variable-length code table generation section 10 may include a variable-length code table generation section 20. The variable-length code table generation section 20 generates a variable-length code table (B) based on the symbol data (A). The variable-length code table (B) is information indicating the relationship between each symbol and the code word. The variable-length code table generation section 20 may perform a statistical information generation process which generates statistical information indicating the occurrence rate of each symbol of the symbol data (A), and a code word assignment process which determines a code word assigned to each symbol based on the generated statistical information. The variable-length code table (B) shown in FIG. 8 is thus generated. In the example shown in FIG. 8, since group numbers 9 to 11 do not occur (occurrence count: 0), a code word (identification symbol) need not be assigned to the group numbers 9 to 11 when creating a code table optimum for the first image data 102. In the invention, second image data 202 is compressed utilizing the variable-length code table (B). Therefore, it is preferable to assign code words to the group numbers 9 to 11, as shown in FIG. 8. As a modification, a code table may be generated so that a code word is not assigned to a group number which does not occur.

The variable-length code table generation section 10 according to this embodiment may be configured as described above. Note that the encoding device according to the invention is not limited to the above configuration. In particular, the processing section (i.e., processing section which generates data (symbol data (A)) to which a code word is assigned) upstream of the variable-length code table generation section 20 may be modified in various ways. A processing section which performs a process appropriate for the encoding method (data compression method) employed may be applied.

As shown in FIG. 1, the encoding device 1 according to this embodiment may include a holding section 22 which holds the variable-length code table (B). The holding section 22 may be implemented by a known memory device. An encoded information generation section 30 described later may read the variable-length code table (B) held in the holding section 22, and generate encoded information (E). In this case, the encoding device 1 may be configured to encode a plurality of pieces of second image data 202 acquired in time series based on one variable-length code table (B) held in the holding section 22. Note that the encoding device 1 may not include the holding section 22. In this case, the encoding device I may encode only one piece of the second image data 202 based on the variable-length code table (B) generated based on one piece of the first image data 102.

As shown in FIG. 1, the encoding device 1 according to this embodiment includes an encoding section 24. The encoding section 24 generates encoded information (C) by assigning a code word to the symbol data (A). Specifically, the encoding section 24 generates the encoded information (C) by encoding the symbol data (A). The encoded information (C) is encoded information (compressed data) relating to the first image data 102. Specifically, the encoding section 24 generates encoded information relating to the first image data 102.

The encoding section 24 may generate the encoded information (C) based on the variable-length code table (B) held in the holding section 22. For example, when the encoding device 1 is configured to sequentially generate code tables based on a plurality of pieces of the first image data 102 acquired in time series, the generated variable-length code table (B) may be held in the holding section 22, and the first image data 102 (symbol data (A)) subsequently acquired may be encoded based on the variable-length code table (B) held in the holding section 22. The encoding section 24 may generate the encoded information (C) based on a predetermined de-facto code table (variable-length code table).

When the encoding device 1 includes the encoding section 24, the block division section 12, the DCT conversion section 14, the quantization section 16, the symbol data generation section 18, and the encoding section 24 may be collectively referred to as a first JPEG encoder 25. Note that the encoding device 1 may not include the encoding section 24.

The configuration of the encoding device 1 according to this embodiment for processing the second image data 202 is described below.

As shown in FIG. 1, the encoding device 1 according to this embodiment includes the encoded information generation section 30. The encoded information generation section 30 encodes the second image data 202 (symbol data (D)) acquired using a second imaging section based on the variable-length code table (B) to generate encoded information (E). The encoded information generation section 30 may include a block division section 32, a DCT conversion section 34, a quantization section 36, a symbol data generation section 38, and an encoding section 40.

The block division processing section 32 divides the second image data 202 acquired using the second imaging section to generate block data 204 (see FIGS. 4A and 4B).

The DCT conversion section 34 performs a DCT conversion process on each piece of the block data 204 to generate DCT coefficients 206 (see FIG. 5).

The quantization section 36 quantizes the DCT coefficients 206 to generate quantized DCT coefficients 208 (see FIG. 6). The quantization section 36 may quantize the DCT coefficients 206 based on the same quantization table 110 (see FIG. 7) as the quantization section 16 of the variable-length code table generation section 10.

The symbol data generation section 38 converts the quantized DCT coefficients 208 (or DCT coefficients 206) to generate symbol data (D).

Each process of generating the symbol data (D) from the second image data 202 may be the same as each process of generating the symbol data (A) from the first image data 102.

The encoding section 40 encodes the symbol data (D) based on the variable-length code table (B) to generate the encoded information (E). Specifically, the encoding section 40 may generate the encoded information (E) by associating the code word assigned in the variable-length code table (B) with each symbol generated by the symbol data generation section 38. The encoded information generation section 30 may be referred to as a second JPEG encoder 35.

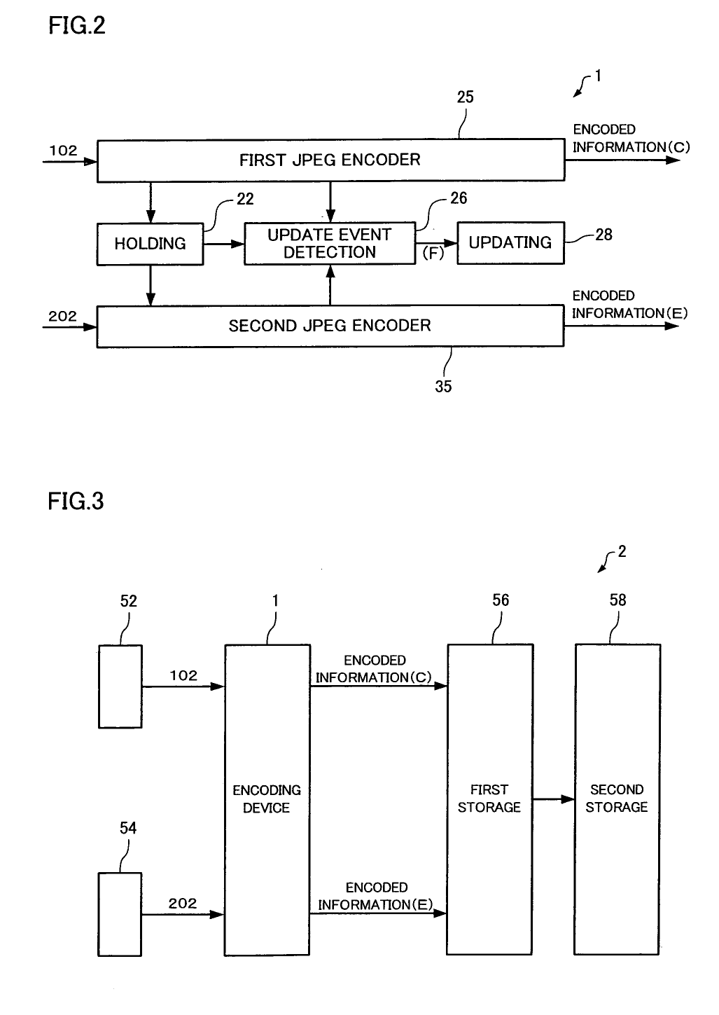

As shown in FIG. 2, the encoding device 1 according to this embodiment may include an update event detection section 26. The update event detection section 26 may be configured to detect that an update event of the variable-length code table (B) held in the holding section 22 has occurred and output a detection signal (F).

The update event detection section 26 may be configured to detect that the amount of encoded information (E) generated by the encoding section 40 has exceeded a predetermined value and output the detection signal (F), for example.

The update event detection section 26 may be configured to detect that a predetermined period of time has expired after the first image data 102 from which the variable-length code table (B) held in the holding section 22 has been generated has been acquired and output the detection signal (F).

The update event detection section 26 may be configured to detect that a predetermined period of time has expired after the variable-length code table (B) has been written into the holding section 22 and output the detection signal (F).

The update event detection section 26 may be configured to detect that an update time set in advance has been reached using a built-in timer and output the detection signal (F), for example.

The update event detection section 26 may be configured to detect that new first image data 102 (new symbol data (A) or variable-length code table (B)) has been generated and output the detection signal (F).

The update event detection section 26 may be configured to detect that the first image data 102 or the second image data 202 satisfies a predetermined condition and output the detection signal (F). Specifically, the update event detection section 26 may determine whether or not to update the variable-length code table (B) held in the holding section 22 based on the image data before being encoded. The update event detection section 26 may determine whether or not to update the variable-length code table (B) based on the luminances (total luminance) of the first image data 102 and the second image data 202, for example.

As shown in FIG. 2, the encoding device 1 according to this embodiment may include an updating section 28. The updating section 28 updates the variable-length code table (B) held in the holding section 22 when the update event detection section 26 has detected that the update event has occurred (i.e., when receiving the detection signal (F) from the update event detection section 26). Specifically, the updating section 28 rewrites the information held in the holding section 22 with a new variable-length code table (B).

The updating section 28 may be configured to be able to control the operation of the first imaging section. Specifically, the updating section 28 may generate a control signal that controls the first imaging section to cause the first imaging section to acquire new first image data 102, and may hold a variable-length code table (B) generated based on the acquired first image data 102 in the holding section 22. The first imaging section may be configured to acquire the first image data 102 at predetermined time intervals irrespective of the operation of the updating section 28.

The encoding device I according to this embodiment may be configured as described above. The encoding device I may be implemented by dedicated hardware, or may be implemented by causing a microcomputer including a CPU or an MPU to execute a predetermined program.

The encoding device 1 may be configured as part of the image recording device 2. The configuration of the image recording device 2 including the encoding device 1 is described below with reference to FIG. 3.

As shown in FIG. 3, the image recording device 2 includes a first imaging section 52 and a second imaging section 54. The first and second imaging sections 52 and 54 may include a light-receiving element which converts incident light into an electrical signal, an optical element (optical system) (e.g., lens and mirror) which causes light to be incident on the light-receiving element, and a processing section which performs a predetermined process on the electrical signal output from the light-receiving element, for example. The first image data 102 and the second image data 202 acquired using the first and second imaging sections 52 and 54 are subjected to the encoding process. In this embodiment, the first and second imaging sections 52 and 54 may be configured to perform an identical process on the incident light. For example, the first and second imaging sections 52 and 54 may have an identical setting relating to a sharpening function, a smoothing feature, or a color filter. The first and second imaging sections 52 and 54 may have an identical setting relating to a focal length. Specifically, in this embodiment, the optical elements, the light-receiving elements, and the processing sections of the first and second imaging sections 52 and 54 may have an identical setting. The first and second imaging sections 52 and 54 may be disposed adjacently and face in an identical direction.

The image recording device 2 may be configured as a drive recorder, for example. In this case, the first and second imaging sections 52 and 54 may be provided in one vehicle.

As shown in FIG. 3, the image recording device 2 includes a first storage section 56. The encoded information (E) generated by the encoding section 40 is written into the first storage section 56. When the encoding device 1 includes the encoding section 24, the encoded information (C) may be written into the first storage section 56. The first storage section 56 may be implemented by a known storage element.

As shown in FIG. 3, the image recording device 2 may include a second storage section 58. The second storage section 58 stores the information (encoded information) which has been written into the first storage section 56 when a predetermined event has occurred. The second storage section 58 may include a nonvolatile memory.

The image recording device 2 may include a control section (not shown) which controls the operation of the image recording device 2. The control section may be implemented by causing a microcomputer including a CPU or an MPU to execute a predetermined program, or may be implemented by a dedicated circuit, for example.

The control section may store data written into the first storage section 56 in the second storage section 58 (data storage process). The control section may be configured to receive a detection signal from a data storage event detection section (not shown) and then start the data storage process. The data storage event detection section may include a vibration detection sensor such as an acceleration sensor or an angular speed sensor. The data storage event detection section may be configured to generate the detection signal when the vibration detection sensor has detected predetermined vibrations.

The control section may control the imaging operations of the first and second imaging sections 52 and 54. The control section may control the operations of the first and second imaging sections 52 and 54 by setting the imaging time intervals of the first and second imaging sections 52 and 54. The control section may generate a control signal which causes the first imaging section 52 to acquire the first image data 102 when the update event detection section 26 has detected an update event. The control section may adjust the directions and the focal lengths of the first and second imaging sections 52 and 54.

2. Operation of Encoding Device 1

The operation of the encoding device 1 according to this embodiment is described below. FIGS. 9 to 14 are views illustrative of the operation of the encoding device 1.

The encoding device 1 generates the variable-length code table (B). FIG. 9 is a flowchart illustrative of the variable-length code table generation process.

The encoding device 1 divides the first image data 102 into N blocks to generate the block data 104 (step S10).

The encoding device 1 performs the DCT conversion process on the block data 104 to generate the DCT coefficients 106 (step S12).

The encoding device 1 quantizes the DCT coefficients 106 to generate the quantized DCT coefficients 108 (step S14).

The encoding device 1 converts the quantized DCT coefficients 108 to generate the symbol data (A) (step S16), and increments the symbols (step S18) to generate the statistical information which indicates the occurrence rates of the symbols.

When the symbol incrementing operation has been completed for all (N) pieces of block data 104 (Yes in step S20), the encoding device 1 determines the code word assigned to each symbol based on the generated statistical information to generate the variable-length code table (B) shown in FIG. 8 (step S22).

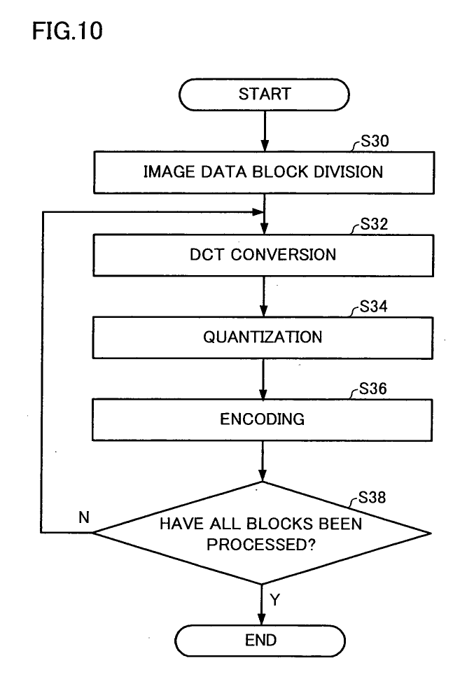

The encoding device 1 encodes the second image data 202 based on the generated variable-length code table (B). FIG. 10 is a view illustrative of the process of encoding the second image data 202 to generate the encoded information (E).

The encoding device 1 divides the second image data 202 into N blocks to generate the block data 204 (step S30).

The encoding device 1 performs the DCT conversion process on the block data 204 to generate the DCT coefficients 206 (step S32).

The encoding device 1 quantizes the DCT coefficients 206 to generate the quantized DCT coefficients 208 (step S34).

The encoding device 1 converts the quantized DCT coefficients 208 into symbol information based on the variable-length code table (B) to generate the encoded information (E) (step S36).

The second image data 202 can be encoded by performing each process on all pieces of the block data 204 (Yes in step S38).

3. Effects

Effects of the encoding device 1 (image recording device 2) according to this embodiment are described below.

As described above, the encoding device 1 encodes the second image data 202 based on the variable-length code table (B) generated based on the first image data 102. This enables the second image data 202 to be encoded without generating a variable-length code table based on the second image data 202. Therefore, the second image data 202 can be efficiently encoded in real time. Since the second image data 202 is encoded based on the variable-length code table (B) generated based on the first image data 102, the second image data 202 can be encoded at a high compression rate as compared with the case of using a de-facto code table. Specifically, the encoding device 1 can encode the second image data 202 in real time at a high compression rate. For example, even when the second imaging section 54 acquires the second image data 202 at a rate of about 30 frames per second, the encoding device 1 can encode the second image data 202 in real time at a high compression rate.

When the first image data 102 and the second image data 202 are similar types of image data and the variable-length code table generation section 10 generates a code table optimum for encoding the first image data 102 (i.e., the amount of the first image data 102 becomes equal to or less than a predetermined value after encoding), the second image data 202 can be encoded at a higher compression rate.

In general, variable-length code tables (symbol statistical information) generated based on pieces of image data having similar features contain similar types of data. Therefore, when the first image data 102 and the second image data 202 are similar types of data, the variable-length code table (B) optimum for the first image data 102 is optimum for encoding the second image data 202. Therefore, when the first image data 102 and the second image data 202 are similar types of image data, the second image data 202 can be encoded at a higher compression rate by encoding the second image data 202 based on the variable-length code table (B) optimum for the first image data 102.

In the invention, similar types of first image data 102 and second image data 202 can be acquired by adjacently disposing the first imaging section 52 and the second imaging section 54 to face an identical direction and acquiring the first image data 102 and the second image data 202 at close timing, for example. Therefore, the second image data 202 can be encoded at a high compression rate by setting the first and second imaging sections 52 and 54 as described above.

Note that the second image data 202 can be encoded at a high compression rate based on the variable-length code table (B) generated based on the first image data 102 even if the first and second imaging sections 52 and 54 are not adjacently disposed or disposed to face different directions. For example, when the encoding device 1 (image recording device 2) is configured as a drive recorder and the first and second imaging sections 52 and 54 are provided in one vehicle, the first image data 102 and the second image data 202 may contain components showing similar features (e.g., DC components of the Y component) even if the first and second imaging sections 52 and 54 are disposed to face different directions. Therefore, the second image data 202 can be encoded in real time at a high compression rate by utilizing the variable-length code table (B) of similar components.

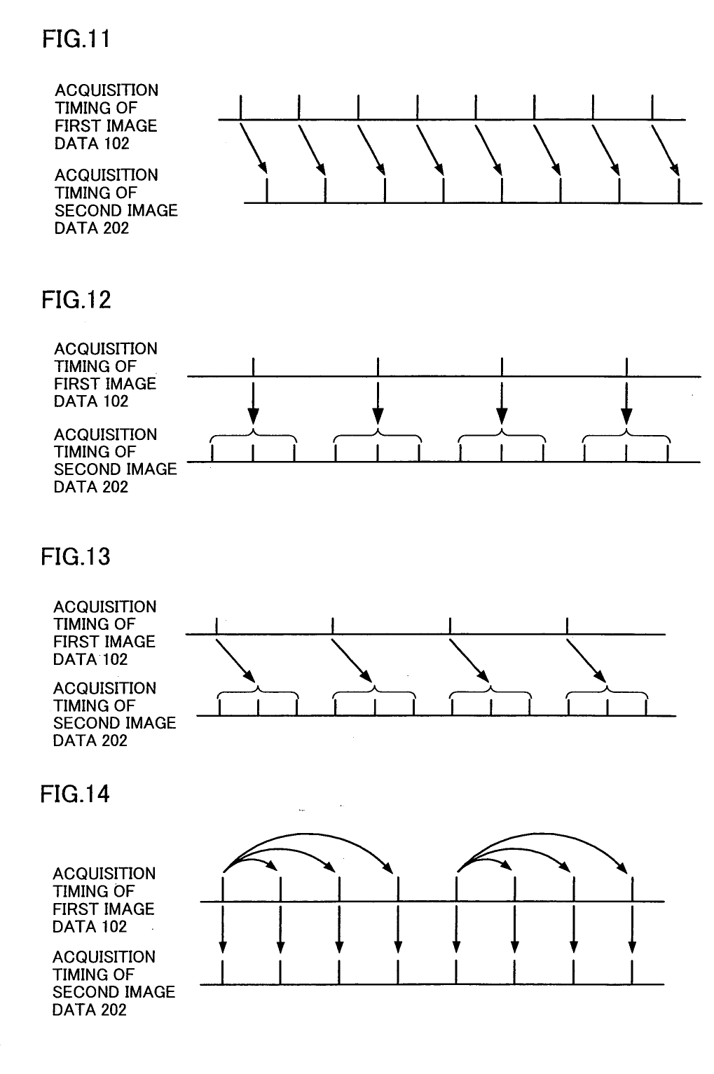

The encoding device 1 (image recording device 2) may be configured so that the first imaging section 52 and the second imaging section 54 acquire (image) image data at (almost) the same timing. The first and second imaging sections 52 and 54 may be configured to acquire image data at identical time intervals, as shown in FIG. 11, for example. The encoding section 40 may generate the encoded information (E) based on the variable-length code table (B) generated based on the first image data 102 acquired immediately before the encoding target second image data 202, as shown in FIG. 11. In FIG. 11, straight lines indicate the timings at which the first and second imaging sections 52 and 54 perform imaging operations, and arrows indicate delivery of the variable-length code table (B). Specifically, the variable-length code table (B) generated based on the first image data 102 acquired at the timing indicated by the starting point of the arrow is utilized to encode the image data (second image data 202) acquired at the timing indicated by the end point of the arrow. This enables the encoding section 40 to always encode the second image data 202 utilizing the variable-length code table (B) generated based on the first image data 102 acquired immediately before the second image data 202, whereby the second image data 202 can be encoded at a high compression rate.

As shown in FIG. 12, the imaging time interval of the first imaging section 52 may be longer than the imaging time interval of the second imaging section 54. In this case, the encoding section 40 may generate the encoded information (E) based on the variable-length code table (B) generated based on the first image data 102 acquired at a timing closest to the encoding target second image data 202. This also enables the second image data 202 to be encoded at a high compression rate.

When the imaging time interval of the first imaging section 52 may be longer than the imaging time interval of the second imaging section 54, the encoding section 40 may generate the encoded information (E) based on the variable-length code table (B) generated based on the first image data 102 acquired immediately before the encoding target second image data 202 and held in the holding section 22, as shown in FIG. 13.

The first imaging section 52 may be configured to acquire the first image data 102 only when the update event detection section 26 has detected that an update event has occurred, without setting the imaging time interval of the first imaging section 52. The update event detection section 26 may be configured to generate the update event detection signal when the amount of encoded information (E) has exceeded a predetermined value, for example. When the amount of encoded information (E) has exceeded a predetermined value, it may be determined that the second image data 202 has been encoded based on an inappropriate code table. Specifically, when the amount of encoded information (E) has exceeded a predetermined value, it may be determined that the environment of the encoding device 1 has changed (i.e., scene change has occurred) as compared with the time at which the variable-length code table (B) held in the holding section 22 has been generated. Therefore, if the variable-length code table (B) held in the holding section 22 is updated based on the newly acquired first image data 102 when the amount of encoded information (E) has exceeded a predetermined value, the second image data 202 subsequently acquired can be encoded at a high compression rate.

When the encoding device 1 (image recording device 2) includes the encoding section 24 which encodes the first image data 102, the encoding section 24 may encode the first image data 102 based on the variable-length code table (B) generated based on the first image data 102 which has been acquired, as shown in FIG. 14. This enables the first image data 102 to be encoded at a high compression rate.

4. Modifications

The invention is not limited to the above-described embodiments, and various modifications can be made. For example, the invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

For example, the encoding device 1 may hold the symbol statistical information in the holding section 22, and the encoding section 40 may generate a variable-length code table based on the statistical information held in the holding section 22 and encode the second image data 202.

The image recording device 2 (encoding device 1) may include three or more imaging sections. The image recording device 2 (encoding device 1) may generate a code table based on image data acquired by one imaging section, and encode image data acquired by the remaining imaging sections based on the generated code table.

The resolution of the first imaging section 52 may be set to be lower than that of the second imaging section 54. Since the load of processing the first image data 102 is reduced by decreasing the resolution of the first imaging section 52, the variable-length code table (B) can be efficiently generated. Since pieces of image data may contain a common feature even when using an imaging section with a low resolution, the second image data 202 can be encoded at a high compression rate based on the variable-length code table (B) generated based on the first image data 102.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. An encoding device comprising:
a variable-length code table generation section generating a variable-length code table based on first image data acquired by a first imaging section; and
an encoded information generation section generating encoded information by encoding second image data acquired by a second imaging section based on the variable-length code table generated by the variable-length code table generation section.

2. The encoding device as defined in claim 1,
wherein the first imaging section acquires a plurality of pieces of the first image data in time series; and
wherein the variable-length code table generation section generates a plurality of the variable-length code tables, each of the variable-length code tables being generated based on one of the pieces of the first image data.

3. The encoding device as defined in claim 2,
wherein the encoded information generation section encodes the second image data based on one of the variable-length code tables generated based on one of the pieces of the first image data having an acquisition time closest to an acquisition time of the second image data.

4. The encoding device as defined in claim 2,
wherein the encoded information generation section encodes the second image data based on one of the variable-length code tables generated based on one of the pieces of the first image data having an acquisition time immediately before an acquisition time of the second image data.

5. The encoding device as defined in claim 1, further comprising:
a holding section holding the variable-length code table,
wherein the encoded information generation section encodes at least two pieces of the second image data based on the variable-length code table held in the holding section.

6. The encoding device as defined in claim 5, further comprising:
an update event detection section detecting occurrence of a predetermined variable-length code table update event; and
an updating section updating the variable-length code table held in the holding section when the update event detection section has detected the occurrence of the predetermined variable-length code table update event.

7. The encoding device as defined in claim 6,
wherein the update event detection section detects the occurrence of the predetermined variable-length code table update event when the amount of the encoded information has exceeded a predetermined value.

8. The encoding device as defined in claim 6,
wherein the update event detection section detects the occurrence of the predetermined variable-length code table update event when a predetermined period of time has expired after the acquisition of the first image data.

9. The encoding device as defined in claim 6,
wherein the update event detection section detects the occurrence of the predetermined variable-length code table update event when a predetermined period of time has expired after the variable-length code table has been held in the holding section.

10. The encoding device as defined in claim 6,
wherein the update event detection section detects the occurrence of the predetermined variable-length code table update event when a predetermined update time is reached.

11. The encoding device as defined in claim 6,
wherein the update event detection section detects the occurrence of the predetermined variable-length code table update event when the first image data or the second image data satisfies a predetermined condition.

12. The encoding device as defined in claim 6,
wherein the updating section causes the first imaging section to newly acquire the first image data when the update event detection section has detected the occurrence of the predetermined variable-length code table update event.

13. The encoding device as defined in claim 1, wherein a resolution of the first image data is lower than a resolution of the second image data.

14. The encoding device as defined in claim 1, further comprising a first image data encoding section encoding the first image data to generate encoded information.

15. The encoding device as defined in claim 14,
wherein the first image data encoding section encodes the first image data based on the variable-length code table.

16. The encoding device as defined in claim 14,
wherein the variable-length code table generation section generates the variable-length code table so that the amount of information of the first image data is equal to or less than a predetermined value after encoding the first image data based on the variable-length code table.

17. An image recording device comprising:
the encoding device as defined in claim 1;
the first imaging section;
the second imaging section; and
a storage section storing the encoded information.

18. The image recording device as defined in claim 17,
wherein the first imaging section and the second imaging section are disposed adjacently and face in an identical direction.

19. The image recording device as defined in claim 17,
wherein the first image data and the second image data are acquired by performing an identical process on light incident on the first imaging section and the second imaging section.

20. The image recording device as defined in claim 17, wherein the first imaging section and the second imaging section are provided in one vehicle.
